(19) United States
(12) Patent Application Publication
(10) Pub. No.: US 2022/0307871 A1
(43) Pub. Date: Sep. 29, 2022

(54) OPTICAL FIBER SENSING SYSTEM AND OPTICAL FIBER SENSING METHOD

(71) Applicant: NEC Corporation, Minato-ku, Tokyo (JP)

(72) Inventor: Takashi KOJIMA, Tokyo (JP)

(73) Assignee: NEC Corporation, Minato-ku, Tokyo (JP)

(21) Appl. No.: 17/635,592

(22) PCT Filed: Aug. 23, 2019
(86) PCT No.: PCT/JP2019/032932

§ 371 Date: Feb. 15, 2022

(51) Int. Cl. G01D 5/353; G01M 11/00; G08B 13/186

(52) U.S. Cl. CPC G01D 5/353; G01M 11/30; G08B 13/186

(57) ABSTRACT

The optical fiber sensing method according to the present disclosure includes: sensing optical fibers being redundantly laid (10A1, 10A2); an execution unit (22) that executes sensing with the sensing optical fibers (10A1, 10A2); a detection unit (23) that detects occurrence of a fault in the sensing optical fiber (10A1) of an active system among the sensing optical fibers (10A1, 10A2); and a switching unit (21) that performs switching in such a way that the execution unit (22) executes sensing with the sensing optical fiber (10A2) of a standby system among the sensing optical fibers (10A1, 10A2) when the detection unit (23) detects occurrence of a fault.

### TECHNICAL FIELD

The present disclosure relates to an optical fiber sensing system and an optical fiber sensing method.

### BACKGROUND ART

In recent years, there has been a technique of performing sensing by using an optical fiber as a sensor. Further, recently, a technique of detecting suspicious behavior or intrusion of a person or the like by using sensing with an optical fiber has been proposed.

In a case where the above-mentioned detection is performed, sensing in a wide area has to be continuously performed. Meanwhile, due to occurrence of a fault or the like in an optical fiber, there is a possibility that sensing is interrupted against intention of a user, and an area or a time period in which detection cannot be performed may occur (so-called, occurrence of a security hole). Therefore, it is necessary to consider a countermeasure in a case where a fault occurs in an optical fiber.

For example, Patent Literature 1 discloses a technique of coping with a failure by using, for sensing, one optical fiber out of two optical fibers arranged in parallel and using the other optical fiber as a spare.

### CITATION LIST

### Patent Literature

[Patent Literature 1] Japanese Unexamined Patent Application Publication No. 2011-058835

### SUMMARY OF INVENTION

### Technical Problem

However, Patent Literature 1 does not disclose any method of switching to a spare optical fiber when a failure occurs. Therefore, a problem that a security hole occurs when a fault occurs in an optical fiber remains.

Therefore, an object of the present disclosure is to solve the above-mentioned problem, and to provide an optical fiber sensing system and an optical fiber sensing method that are capable of suppressing occurrence of a security hole to a minimum by continuing sensing with an optical fiber when a fault occurs in the optical fiber.

### Solution to Problem

An optical fiber sensing system according to a first aspect includes:

a sensing optical fiber configured to be redundantly laid;

an execution unit configured to execute sensing with the sensing optical fiber;

a detection unit configured to detect occurrence of a fault in a sensing optical fiber of an active system among the sensing optical fibers; and

a switching unit configured to perform switching in such a way that the execution unit executes sensing with a sensing optical fiber of a standby system among the sensing optical fibers when the detection unit detects occurrence of the fault.

An optical fiber sensing system according to a second aspect includes:

a first sensing unit configured to include a first sensing optical fiber and execute sensing with the first sensing optical fiber;

a second sensing unit configured to include a second sensing optical fiber and execute sensing with the second sensing optical fiber; and

a control device configured to detect an operating state of each of the first sensing unit and the second sensing unit,

wherein the control device performs switching in such a way as to execute sensing with the second sensing unit when it is detected that the first sensing unit becomes inoperable in a case where the first sensing unit is in an active system.

An optical fiber sensing method according to a first aspect is an optical fiber sensing method by an optical fiber sensing system, and includes:

a detection step of detecting occurrence of a fault in a sensing optical fiber of an active system among sensing optical fibers being redundantly laid; and

a switching step of performing switching in such a way as to execute sensing with a sensing optical fiber of a standby system among the sensing optical fibers when occurrence of the fault is detected in the detection step.

An optical fiber sensing method according to a second aspect is an optical fiber sensing method by an optical fiber sensing system, wherein

the optical fiber sensing system includes

a first sensing unit that includes a first sensing optical fiber and executes sensing with the first sensing optical fiber, and

a second sensing unit that includes a second sensing optical fiber and executes sensing with the second sensing optical fiber, and

the optical fiber sensing method includes

a detection step of detecting an operating state of each of the first sensing unit and the second sensing unit, and

a switching step of performing switching in such a way as to execute sensing with the second sensing unit when it is detected, in the detection step, that the first sensing unit becomes inoperable in a case where the first sensing unit is in an active system.

### Advantageous Effects of Invention

According to the above-mentioned aspects, it is possible to acquire an advantageous effect of being able to provide an optical fiber sensing system and an optical fiber sensing method that are capable of continuing sensing with an optical fiber and suppressing occurrence of a security hole to a minimum even when a fault occurs in the optical fiber.

### BRIEF DESCRIPTION OF THE DRAWINGS

FIG. 1 is a diagram illustrating a configuration example of an optical fiber sensing system according to a first example embodiment.

FIG. 2 is a diagram illustrating a configuration example of a connection portion with an optical fiber in a switching unit according to the first example embodiment.

FIG. 3 is a flow chart illustrating an operation example of the optical fiber sensing system according to the first example embodiment.

FIG. 4 is a diagram illustrating a configuration example of the optical fiber sensing system according to a first modification example of the first example embodiment.

FIG. 5 is a diagram illustrating a configuration example of the optical fiber sensing system according to a second modification example of the first example embodiment.

FIG. 6 is a diagram illustrating a configuration example of an optical fiber sensing system according to a second example embodiment.

FIG. 7 is a flow chart illustrating an operation example of the optical fiber sensing system according to the second example embodiment.

FIG. 8 is a diagram illustrating a configuration example of the optical fiber sensing system according to a first modification example of the second example embodiment.

FIG. 9 is a diagram illustrating a schematic configuration example of the optical fiber sensing system according to a second modification example of the second example embodiment.

FIG. 10 is a diagram illustrating a configuration example of an optical fiber sensing system according to a third example embodiment.

FIG. 11 is a flow chart illustrating an operation example of the optical fiber sensing system according to the third example embodiment.

FIG. 12 is a diagram illustrating a configuration example of the optical fiber sensing system according to a first modification example of the third example embodiment.

FIG. 13 is a diagram illustrating a configuration example of an optical fiber sensing system according to another example embodiment.

FIG. 14 is a diagram illustrating an example of a GUI screen used for notification by a notification unit according to the another example embodiment.

FIG. 15 is a block diagram illustrating an example of a hardware configuration of a computer for achieving optical fiber sensing equipment according to the example embodiment.

### DESCRIPTION OF EMBODIMENTS

Example embodiments of the present disclosure will be described below with reference to the drawings. Note that, the following description and the drawings are appropriately omitted and simplified for clarity of description. Further, in the following drawings, the same elements are denoted by the same reference signs, and a repetitive description thereof is omitted as necessary.

### First Example Embodiment

First, a configuration example of an optical fiber sensing system according to a first example embodiment will be described with reference to FIG. 1.

As illustrated in FIG. 1, the optical fiber sensing system according to the first example embodiment includes optical fibers 10A1 and 10A2, and optical fiber sensing equipment 20. Further, the optical fiber sensing equipment 20 includes a processing unit 24. Furthermore, the processing unit 24 includes a switching unit 21, an execution unit 22, and a detection unit 23. Note that, in the following description, when simply referred to as an “optical fiber 10”, it means that which optical fiber is (in a case in FIG. 1, which of the optical fibers 10A1 and 10A2 is) is not specified.

The optical fibers 10A1 and 10A2 are sensing optical fibers that are redundantly laid in a monitoring area. The monitoring area is an area in which sensing is executed with the optical fibers 10A1 and 10A2 in order to detect suspicious behavior or intrusion of a person, or the like, and is, for example, a border, a prison, a commercial facility, an airport, a hospital, a town, a port, a plant, a nursing facility, an office building, a nursery school, a home, or the like. When the optical fibers 10A1 and 10A2 are laid in the monitoring area, the optical fibers 10A1 and 10A2 can be provided inside a pipe provided in the monitoring area, for example. At this time, the optical fibers 10A1 and 10A2 may be provided inside the same pipe, or may be provided inside pipes different from each other.

One of the optical fibers 10A1 and 10A2 is an active system, and the other is a standby system. In a state illustrated in FIG. 1, the optical fiber 10A1 is the active system, and the optical fiber 10A2 is the standby system. Note that, FIG. 1 illustrates an example in which the two optical fibers 10A1 and 10A2 are provided, one of which is the active system, and the other of which is the standby system, but the present invention is not limited thereto. For example, three or more optical fibers 10 may be provided, and one of the optical fibers 10 may be used as the active system, and the remaining two or more optical fibers 10 may be used as the standby system.

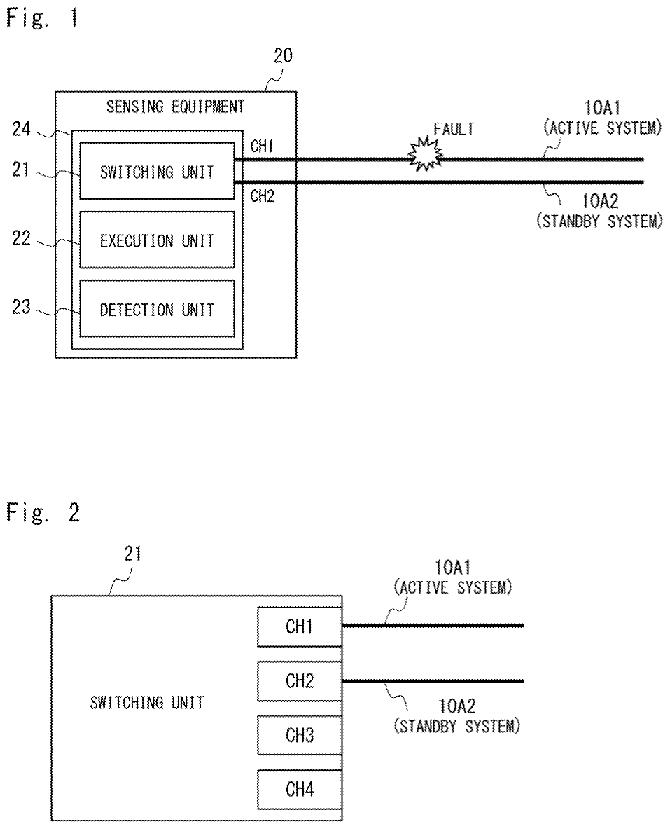

The switching unit 21 includes a plurality of channels CH to which the optical fiber 10 can be connected, and the optical fibers 10A1 and 10A2 are connected to channels CH of the switching unit 21 different from each other. In FIG. 1, the optical fiber 10A1 is connected to a channel CH1, and the optical fiber 10A2 is connected to a channel CH2. FIG. 2 illustrates a configuration example of a connection portion with the optical fiber 10 in the switching unit 21. In FIG. 2, the switching unit 21 includes four channels CH1 to CH4, and four optical fibers 10 can be connected to the switching unit 21. Further, the optical fibers 10A1 and 10A2 are connected to the channels CH1 and CH2, respectively.

In addition, the switching unit 21 performs switching of the active system or the standby system of the plurality of channels CH. At this time, one channel CH among the plurality of channels CH is set as the active system, and the remaining channels CH are set as the standby system. In a state in FIGS. 1 and 2, the channel CH1 becomes the active system, and the remaining channels CH2 to CH4 become the standby system. Note that, the execution unit 22 and the detection unit 23 are connected to the channel CH of the active system by the switching unit 21. In the state in FIGS. 1 and 2, the execution unit 22 and the detection unit 23 are connected to the channel CH1 of the active system, and thereby are connected to the optical fiber 10A1 of the active system via the channel CH1.

The execution unit 22 executes sensing by using the optical fiber 10 of the active system between the optical fibers 10A1 and 10A2. The sensing is executed in the monitoring area, for example, in order to detect suspicious behavior or intrusion of a person, or the like.

In the state in FIG. 1, the execution unit 22 executes sensing by using the optical fiber 10A1 of the active system being connected to the channel CH1 of the active system. At this time, the execution unit 22 enters pulsed light to the optical fiber 10A1. In addition, the execution unit 22 receives, as return light via the optical fiber 10A1, reflected light and scattered light generated by transmitting the pulsed light through the optical fiber 10. The return light includes a specific vibration pattern in which intensity of vibration, a vibration position, transition of change of the number of vibrations, and the like are different in response to an event occurred around the optical fiber 10A1. Therefore, for example, by analyzing dynamic change of a vibration pattern included in the return light, the execution unit 22 can identify an event that has occurred around the optical fiber 10A1 and detect suspicious behavior, intrusion, or the like of a person. Note that, in the present disclosure, since a sensing method itself by using the optical fiber 10 is not an essential matter, a detailed description of the sensing method will be omitted.

The detection unit 23 detects occurrence of a fault in the optical fiber 10 of the active system between the optical fibers 10A1 and 10A2. The fault of the optical fiber 10 is, for example, disconnection, failure, or the like. In the state in FIG. 1, the detection unit 23 detects occurrence of a fault in the optical fiber 10A1 of the active system in the following manner.

In the state in FIG. 1, as described above, return light including a vibration pattern is received from the optical fiber 10A1 of the active system. For example, when a disconnection occurs in the optical fiber 10A1, a large vibration is instantaneously occurred in the vibration pattern included in the return light due to the occurrence of the disconnection. Therefore, when a large vibration occurs instantaneously in the vibration pattern included in the return light, the detection unit 23 determines that a fault has occurred in the optical fiber 10.

Further, the vibration pattern included in the return light received from the optical fiber 10A1 differs depending on an event occurring around the optical fiber 10A1 as described above, but also differs depending on whether a fault has occurred in the optical fiber 10A1. Therefore, the detection unit 23 stores in advance a vibration pattern when a fault occurs in the optical fiber 10A1 as a matching pattern. A plurality of matching patterns may be used. The detection unit 23 compares the vibration pattern included in the return light received from the optical fiber 10A1 with the matching pattern. When a matching ratio between the vibration pattern included in the return light and the matching pattern is equal to or greater than a threshold value, the detection unit 23 determines that a fault has occurred in the optical fiber 10A1. Conversely, the detection unit 23 may store in advance a vibration pattern when the optical fiber 10A1 is normal (i.e., there is no occurrence of a fault) as the matching pattern. In this case, when the matching ratio between the vibration pattern included in the return light and the matching pattern is equal to or greater than the threshold value, the detection unit 23 determines that the optical fiber 10A1 is normal and no fault has occurred.

In the state in FIG. 1, the detection unit 23 detects occurrence of a fault in the optical fiber 10A1 of the active system. When the detection unit 23 determines that a fault has occurred in the optical fiber 10A1 of the active system, the switching unit 21 performs switching the channel CH in such a way that the execution unit 22 continues to execute sensing by using the optical fiber 10A2 of the standby system.

Specifically, the switching unit 21 switches the channel CH1 to which the optical fiber 10A1 is connected from the active system to the standby system, and switches the channel CH2 to which the optical fiber 10A2 is connected from the standby system to the active system. As a result, the execution unit 22 continues sensing by using the optical fiber 10A2 connected to the channel CH2 being switched to the active system.

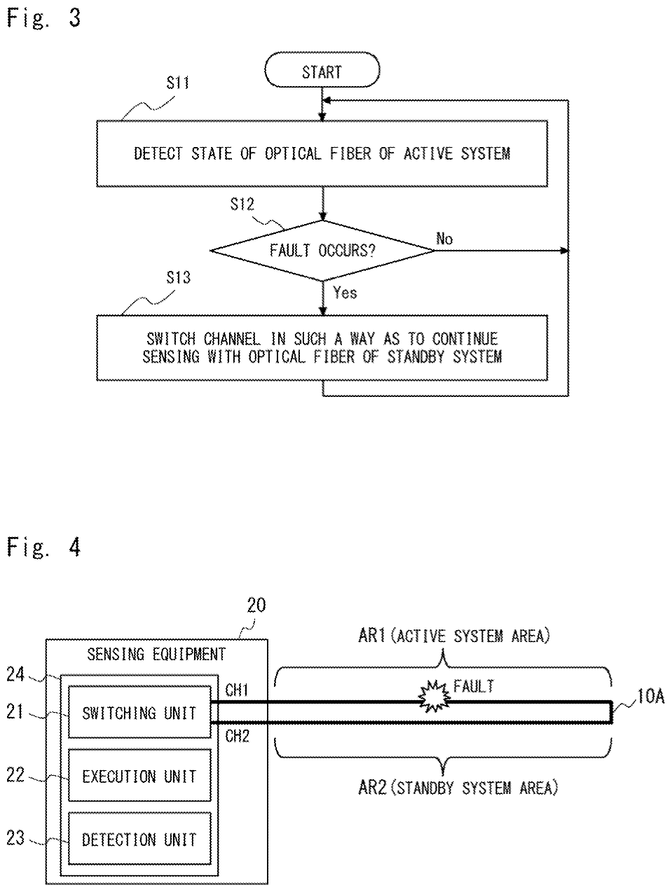

Next, an operation example of the optical fiber sensing system according to the first example embodiment will be described with reference to FIG. 3. Note that, when a flow in FIG. 3 is started, it is assumed that the channel CH1 and the optical fiber 10A1 being connected to the channel CH1 are in the active system.

As illustrated in FIG. 3, first, the detection unit 23 detects a state of the optical fiber 10A1 of the active system (step S11). When the detection unit 23 determines that no fault has occurred in the optical fiber 10A1 of the active system (No in step S12), processing returns to the step S11.

On the other hand, when the detection unit 23 determines that a fault has occurred in the optical fiber 10A1 of the active system (Yes in step S12), the switching unit 21 performs switching the channel CH in such a way that the execution unit 22 continues sensing by using the optical fiber 10A2 of the standby system (step S13). Specifically, the switching unit 21 switches the channel CH1 to which the optical fiber 10A1 is connected from the active system to the standby system, and switches the channel CH2 to which the optical fiber 10A2 is connected from the standby system to the active system.

As described above, according to the first example embodiment, the detection unit 23 detects occurrence of a fault in the optical fiber 10 of the active system. When the detection unit 23 determines that a fault has occurred in the optical fiber 10 of the active system, the switching unit 21 performs switching the channel CH in such a way that the execution unit 22 continues sensing by using the optical fiber 10 of the standby system. Thus, even when a fault occurs in the optical fiber 10 of the active system, sensing can be continued by using the optical fiber 10 of the standby system. As a result, occurrence of a security hole can be suppressed to a minimum.

Next, a modification example of the configuration in FIG. 1 according to the first example embodiment will be described below.

First, a configuration example of the optical fiber sensing system according to a first modification example of the first example embodiment will be described with reference to FIG. 4.

FIG. 1 illustrates an example in which the two optical fibers 10A1 and 10A2 are provided, one of which is the active system and the other of which is the standby system.

On the other hand, as illustrated in FIG. 4, the first modification example of the first example embodiment is an example in which one optical fiber 10A is bent halfway to form a loop structure, both ends of the optical fiber 10A are connected to the switching unit 21, and an active system area and a standby system area are provided in the optical fiber 10A. In a state in FIG. 4, the channel CH1 of the switching unit 21 is in the active system, and an area connected to the channel CH1 is in an active system area AR1. Further, the channel CH2 of the switching unit 21 is a standby system, and an area connected to the channel CH2 is a standby system area AR2.

In the state in FIG. 4, the execution unit 22 executes sensing by using the active system area AR1 connected to the channel CH1 of the active system, and the detection unit 23 detects occurrence of a fault in the active system area AR1. At a time of sensing execution, the execution unit 22 enters pulsed light to the optical fiber 10A from the channel CH1 side of the active system, and receives return light from the channel CH1 side of the active system. Based on a time difference between the time at which the pulsed light is incident and the time at which the return light is received, a distance of the optical fiber 10 from the optical fiber sensing equipment 20 to a position at which the return light is generated can be known. Therefore, the execution unit 22 and the detection unit 23 can determine, by holding an association table in which the distance of the optical fiber 10 and the active system area AR1 are associated with each other, whether the received return light is the return light generated in the active system area AR1.

When the detection unit 23 determines that a fault has occurred in the active system area AR1, the switching unit 21 performs switching the channel CH in such a way that the execution unit 22 continues to execute sensing by using the standby system area AR2. Specifically, the switching unit 21 switches the channel CH1 to which the active system area AR1 is connected from the active system to the standby system, and switches the channel CH2 to which the standby system area AR2 is connected from the standby system to the active system. As a result, the execution unit 22 continues sensing by using the standby system area AR2 connected to the channel CH2 being switched to the active system.

However, within the active system area AR1 in which a fault has occurred, an area from the optical fiber sensing equipment 20 to a fault occurrence position can be used for sensing. Therefore, the switching unit 21 may keep the channel CH1 to which the active system area AR1 is connected as the active system. In this case, the execution unit 22 continues sensing by using the area, within the active system area AR1, from the optical fiber sensing equipment 20 to the fault occurrence position, and the standby system area AR2.

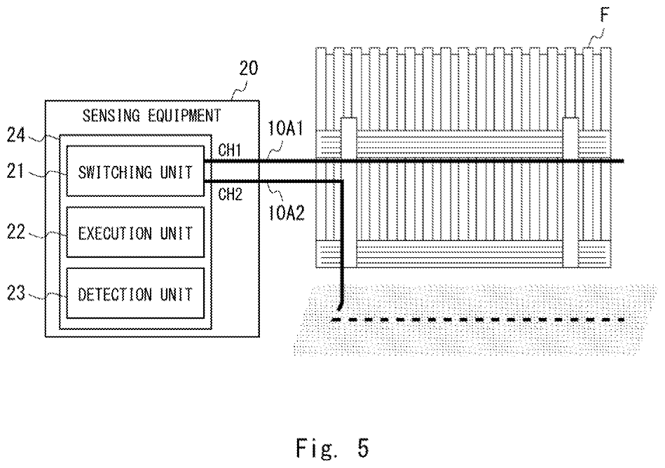

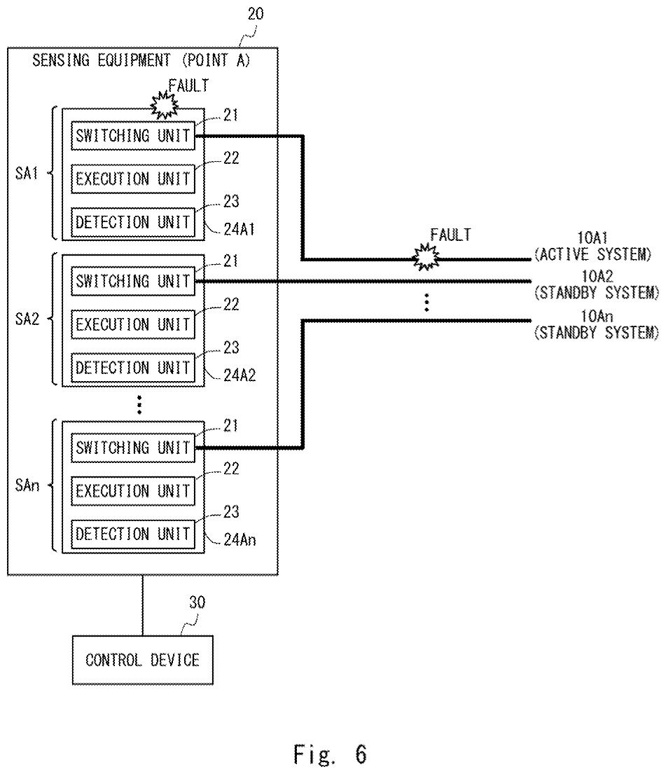

Next, a configuration example of the optical fiber sensing system according to a second modification example of the first example embodiment will be described with reference to FIG. 5.

As illustrated in FIG. 5, the second modification example of the first example embodiment is an example in which one optical fiber 10A1 of the two optical fibers 10A1 and 10A2 is laid on the ground and the other optical fiber 10A2 is laid in the ground. Note that, although FIG. 4 illustrates an example in which the optical fiber 10A1 is laid on a fence F on the ground, the present invention is not limited thereto. A method of laying the optical fiber 10A1 on the ground may be, for example, a method of laying on a wall or the like, or the like. Note that, which of the two optical fibers 10A1 and 10A2 is set as the active system may be optional.

In the second modification example of the first example embodiment, one optical fiber 10A1 is laid on the ground, and the other optical fiber 10A2 is laid in the ground. Therefore, for example, even when a fault occurs in the optical fiber 10A1 due to breakage of the fence F or the like in a case where the optical fiber 10A1 on the ground is in the active system, it is possible to continue sensing by using the optical fiber 10A2 in the ground.

### Second Example Embodiment

The first example embodiment described above is an example in which an optical fiber 10 is redundantly configured.

On the other hand, a second example embodiment is an example in which a unit including a processing unit 24 and the optical fiber 10 is defined as a sensing unit, and the sensing unit is redundantly configured.

First, a configuration example of an optical fiber sensing system according to the second example embodiment will be described with reference to FIG. 6.

As illustrated in FIG. 6, the optical fiber sensing system according to the second example embodiment includes n (n is a natural number of 2 or more) optical fibers 10A1 to 10An, optical fiber sensing equipment 20, and a control device 30. Further, the optical fiber sensing equipment 20 includes n processing units 24A1 to 24An. Note that, the processing units 24A1 to 24An are equivalent to the processing unit 24, and each of the processing units 24A1 to 24An includes a switching unit 21, an execution unit 22, and a detection unit 23. Further, in the following description, when simply referred to as the “processing unit 24”, it means that which processing unit 24 is (in a case in FIG. 6, which of the processing units 24A1 to 24An is) is not specified.

Herein, a unit including the optical fiber 10A1 and the processing unit 24A1 is defined as a sensing unit SA1. Similarly, a unit including the optical fiber 10A2 and the processing unit 24A2 is defined as a sensing unit SA2, and a unit including the optical fiber 10An and the processing unit 24An is defined as a sensing unit SAn. Note that, in the following description, when it is simply referred to as a “sensing unit S”, it means that which sensing unit is (in the case in FIG. 6, which of the sensing units SA1 to SAn is) is not specified.

One of the n sensing units SA1 to SAn is in the active system, and the remaining sensing units are in the standby system. In a state in FIG. 6, the sensing unit SA1 is in the active system, and the remaining sensing units SA2 to SAn are in the standby system.

Note that, in the second example embodiment, the sensing units SA1 to SAn are redundantly configured. Therefore, each of the sensing units SA1 to SAn includes only one optical fiber 10, and a channel CH to which the one optical fiber 10 is connected is constantly treated as the active system. Thus, in each of the sensing units SA1 to SAn, switching of the channel CH becomes unnecessary, and therefore, the switching unit 21 is not an essential component, and whether the switching unit 21 is provided may be optional.

The control device 30 detects an operating state of each of the n sensing units SA1 to SAn. The operating state of the sensing unit SA is, for example, a state of occurrence of a fault (failure or the like) in the processing unit 24, a state of occurrence of a fault (disconnection, failure, or the like) in the optical fiber 10, and the like. The occurrence of a fault in the processing unit 24 is detected by the control device 30 itself. On the other hand, the occurrence of a fault of the optical fiber 10 is detected by using a detection result of the detection unit 23 in the processing unit 24. However, the occurrence of a fault in the optical fiber 10 may also be detected by the control device 30 itself.

Then, the control device 30 determines whether the sensing unit S of the active system among the n sensing units SA1 to SAn becomes inoperable. For example, when a fault occurs in either the optical fiber 10 or the processing unit 24 included in the sensing unit S of the active system, the control device 30 determines that the sensing unit S of the active system becomes inoperable. When it is determined that the sensing unit S of the active system becomes inoperable, the control device 30 performs switching the sensing unit S in such a way as to continue sensing with any of the sensing units S of the standby system.

In the state in FIG. 6, the control device 30 determines whether the sensing unit SA1 of the active system becomes inoperable, and when it is determined that the sensing unit SA1 becomes inoperable, the control device 30 performs switching the sensing unit S in such a way as to continue to execute sensing with any of the sensing units SA2 to SAn of the standby system.

At this time, the control device 30 identifies the sensing unit S in which the processing unit 24 and the optical fiber 10 are normal (i.e., without occurrence of a fault) among the sensing units SA2 to SAn of the standby system as the normal sensing unit S of the standby system, and determines the sensing unit S for executing sensing (i.e., the sensing unit S for switching from the standby system to the active system) from among the normal sensing units S of the standby system.

Further, the control device 30 may take a maintenance state into consideration when determining the sensing unit S for executing sensing from among the normal sensing units S of the standby system. For example, the control device 30 may determine the sensing unit S for executing sensing after excluding the sensing unit S under maintenance. In other words, the control device 30 may determine the sensing unit S for executing sensing from the sensing units S that are not under maintenance among the normal sensing units S of the standby system.

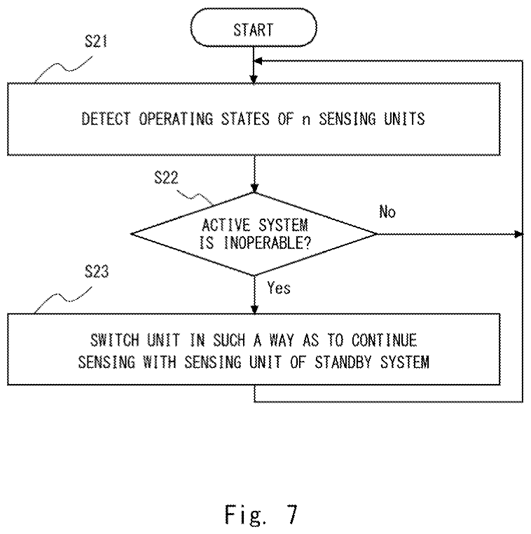

Next, an operation example of the optical fiber sensing system according to the second example embodiment will be described with reference to FIG. 7. Note that, when a flow in FIG. 7 is started, it is assumed that the sensing unit SA1 is in the active system.

As illustrated in FIG. 7, first, the control device 30 detects an operating states of the sensing units SA1 to SAn (step S21), and determines whether the sensing unit SA1 of the active system becomes inoperable (step S22). When it is determined that the sensing unit SA1 of the active system does not become inoperable (No in step S22), processing returns to the step S21.

On the other hand, when it is determined that the sensing unit SA1 of the active system becomes inoperable (Yes in step S22), the control device 30 performs switching the sensing unit S in such a way as to continue to execute sensing with any of the sensing units SA2 to SAn of the standby system (step S23). At this time, the control device 30 determines the sensing unit S for executing sensing from the normal sensing units S among the sensing units SA2 to SAn of the standby system. In addition, the control device 30 may determine the sensing unit S for executing sensing from the sensing units S that are not under maintenance among the normal sensing units S of the standby system.

As described above, according to the second example embodiment, the control device 30 detects operating states of the n sensing units S. When the control device 30 determines that the sensing unit S of the active system becomes inoperable, the control device 30 performs switching the sensing unit S in such a way as to continue to execute sensing with any of the sensing units S of the standby system. Thereby, even when a fault occurs in the optical fiber 10 or the processing unit 24 included in the sensing unit S of the active system, sensing can be continued by any of the sensing units S of the standby system. As a result, occurrence of a security hole can be suppressed to a minimum.

Next, a modification example of the configuration in FIG. 6 according to the second example embodiment will be described below.

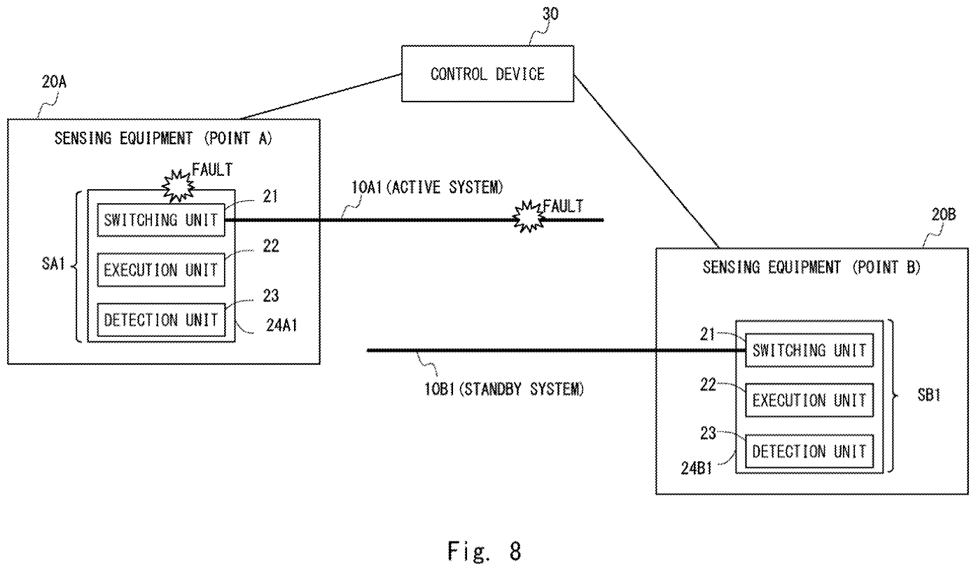

First, a configuration example of the optical fiber sensing system according to a first modification example of the second example embodiment will be described with reference to FIG. 8.

FIG. 6 illustrates an example in which n processing units 24 are arranged at the same point.

On the other hand, as illustrated in FIG. 8, the first modification example of the second example embodiment is an example in which two processing units 24A1 and 24B1 are arranged at points different from each other.

Specifically, in the first modification example of the second example embodiment, the sensing unit SA1 includes the optical fiber 10A1 and the processing unit 24A1, and the processing unit 24A1 is provided in optical fiber sensing equipment 20A arranged at a point A. On the other hand, a sensing unit SB1 includes an optical fiber 10B1 and the processing unit 24B1, and the processing unit 24B1 is provided in optical fiber sensing equipment 20B arranged at a point B. In a state in FIG. 8, the sensing unit SA1 is in the active system, and the sensing unit SB1 is in the standby system. Note that, the optical fibers 10A1 and 10B1 are laid substantially redundantly with respect to each other (laid in substantially the same location or in the same structure, the same shall apply hereinafter).

In the first modification example of the second example embodiment, the two processing units 24A1 and 24B1 are arranged at points different from each other. Therefore, for example, even when a fault occurs in the processing unit 24A1 included in the sensing unit SA1 of the active system due to a fault of the optical fiber sensing equipment 20A itself, sensing can be continued by the sensing unit SB1.

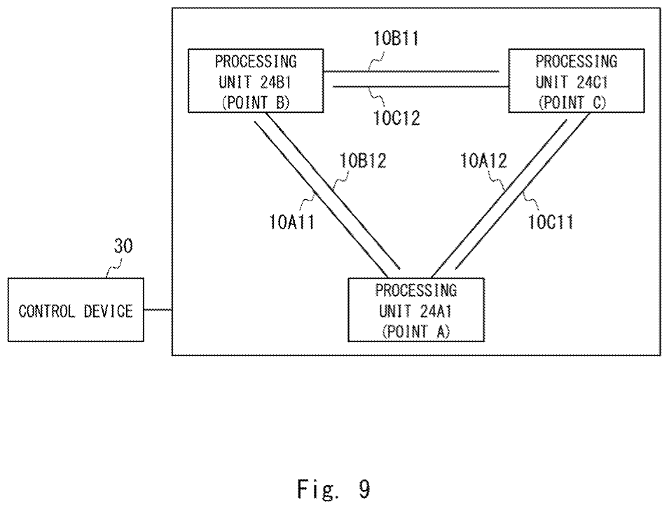

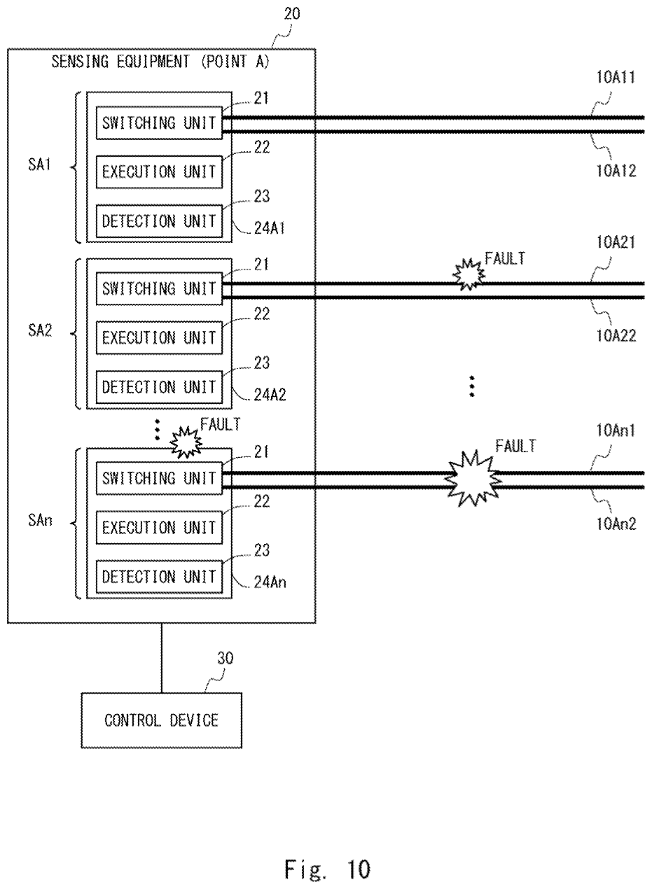

Next, a schematic configuration example of the optical fiber sensing system according to a second modification example of the second example embodiment will be described with reference to FIG. 9.

FIG. 8 according to the first modification example of the second example embodiment described above is an example in which an arranged location of the processing unit 24 is two points.

On the other hand, as illustrated in FIG. 9, the second modification example of the second example embodiment is an example in which the arranged location of the processing unit 24 is three points.

Specifically, in the second modification example of the second example embodiment, the processing unit 24A1 is arranged at the point A, a unit including the processing unit 24A1 and an optical fiber 10A11 is set as one sensing unit S, and a unit including the processing unit 24A1 and an optical fiber 10A12 is set as one sensing unit S. In addition, the processing unit 24B1 is arranged at the point B, a unit including the processing unit 24B1 and an optical fiber 10B11 is set as one sensing unit S, and a unit including the processing unit 24B1 and an optical fiber 10B12 is set as one sensing unit S. Further, a processing unit 24C1 is arranged at a point C, a unit including the processing unit 24C1 and an optical fiber 10C11 is set as one sensing unit S, and a unit including the processing unit 24C1 and an optical fiber 10C12 is set as one sensing unit S. Note that, the optical fibers 10A11 and 10B12 are laid substantially redundantly, the optical fibers 10B11 and 10C12 are laid substantially redundantly, and the optical fibers 10C11 and 10A12 are laid substantially redundantly.

For example, it is assumed that, when the sensing unit S including the processing unit 24A1 and the optical fiber 10A11 is in the active system, the sensing unit S becomes inoperable. In this case, the control device 30 performs switching the sensing unit S in such a way as to continue to execute sensing with the sensing unit S including the processing unit 24B1 and the optical fiber 10B12.

Note that, the second modification example of the second example embodiment is an example in which the arranged location of the processing unit 24 is three points, but the arranged location of the processing unit 24 may be four or more points.

### Third Example Embodiment

The second example embodiment described above is an example in which a sensing unit S is redundantly configured, and each sensing unit S includes one optical fiber 10.

On the other hand, a third example embodiment is an example in which the sensing unit S is redundantly configured, and further, the optical fiber 10 of each sensing unit S is redundantly configured.

First, a configuration example of an optical fiber sensing system according to the third example embodiment will be described with reference to FIG. 10.

As illustrated in FIG. 10, the optical fiber sensing system according to the third example embodiment is different, in comparison with the configuration in FIG. 6 according to the second example embodiment described above, in that each of sensing units SA1 to SAn includes two optical fibers 10 laid on redundantly. In detail, the sensing unit SA1 includes two optical fibers 10A11 and 10A12, the sensing unit SA2 includes two optical fibers 10A21 and 10A22, and the sensing unit SAn includes two optical fibers 10An1 and 10An2. Note that, each of the sensing units SA1 to SAn is not limited to including two optical fibers 10, and may include three or more optical fibers 10.

One of the n sensing units SA1 to SAn is in an active system, and the remaining sensing units are in a standby system. In addition, one of the two optical fibers 10 included in the sensing unit S of the active system is the active system, and the other is the standby system. Further, the two optical fibers 10 included in the sensing unit S of the standby system are both in the standby system.

Note that, in the third example embodiment, since each of the sensing units SA1 to SAn includes two optical fibers 10, it is necessary to switch a channel CH. Therefore, unlike the second example embodiment described above, in each of the sensing units SA1 to SAn, a switching unit 21 is an essential component.

A control device 30 detects an operating state of each of the n sensing units SA1 to SAn. The operating state of the sensing unit S is, for example, a state of occurrence of a fault in the processing unit 24, a state of occurrence of a fault in the two optical fibers 10, and the like.

Then, the control device 30 determines whether a fault has occurred in the optical fiber 10 of the active system between the two optical fibers 10 in the sensing unit S of the active system among the n sensing units SA1 to SAn.

When it is determined that a fault has occurred in the optical fiber 10 of the active system in the sensing unit S of the active system, the control device 30 performs switching the channel CH in such a way as to continue to execute sensing by using the optical fiber 10 of the standby system in the sensing unit S of the active system, or performs switching the sensing unit S in such a way as to continue to execute sensing by using the optical fiber 10 of the standby system in the sensing unit S of the standby system.

For example, it is assumed that the control device 30 determines that a fault has occurred in an optical fiber 10A21 of the active system in the sensing unit SA2 of the active system, as in a state of the sensing unit SA2 in FIG. 10. Then, the control device 30 determines whether it is possible to cope with switching of the channel CH of the sensing unit SA2. For example, when both a processing unit 24A2 and an optical fiber 10A22 of the standby system in the sensing unit SA2 are normal (i.e., there is no occurrence of a fault), the control device 30 determines that it is possible to cope with switching of the channel CH of the sensing unit SA2. When it is determined that it is possible to cope with switching of the channel CH of the sensing unit SA2, the control device 30 performs switching the channel CH in such a way as to continue to execute sensing by using the optical fiber 10A22 of the standby system in the sensing unit SA2 of the active system.

Specifically, the control device 30 instructs the switching unit 21 in the processing unit 24A2 to switch the channel CH to which the optical fiber 10A21 is connected from the active system to the standby system, and to switch the channel CH to which the optical fiber 10A22 is connected from the standby system to the active system.

Alternatively, it is assumed that the control device 30 determines that a fault has occurred in the optical fiber 10An1 of the active system in the sensing unit SAn of the active system, as in a state of the sensing unit SAn in FIG. 10. Then, the control device 30 determines whether it is possible to cope with switching of the channel CH of the sensing unit SAn. For example, when a fault occurs in either a processing unit 24A2 in the sensing unit SAn or an optical fiber 10An2 of the standby system, the control device 30 determines that it is not possible to cope with switching of the channel CH of the sensing unit SA2 and that switching of the sensing unit S is necessary. When it is determined that switching of the sensing unit S is necessary, the control device 30 performs switching the sensing unit S in such a way as to continue to execute sensing by using any of the optical fibers 10 of the standby system in any of the sensing units S of the standby system.

At this time, the control device 30 determines the optical fiber 10 for executing sensing from the optical fibers 10 connected to the normal processing unit 24 among the normal optical fibers 10 of the standby system. In addition, the control device 30 may determine the optical fiber 10 for executing sensing after excluding the optical fiber 10 included in the sensing unit S under maintenance. In other words, the control device 30 may determine the optical fiber 10 for executing sensing from the optical fibers 10 connected to the normal processing unit 24 of the standby system among the normal optical fibers 10 included in the sensing unit S that is not under maintenance.

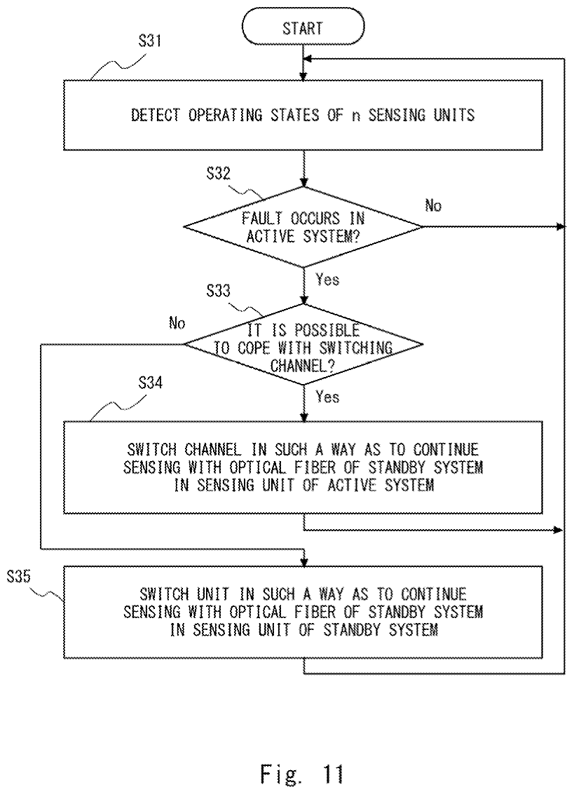

Next, an operation example of the optical fiber sensing system according to the third example embodiment will be described with reference to FIG. 11. Note that, when a flow in FIG. 11 is started, it is assumed that the sensing unit SA1 is in the active system, and the optical fiber 10A11 in the sensing unit SA1 is in the active system.

As illustrated in FIG. 11, first, the control device 30 detects an operating states of the sensing units SA1 to SAn (step S31), and determines whether a fault has occurred in the optical fiber 10A11 of the active system in the sensing unit SA1 of the active system (step S32). When it is determined that a fault has not occurred in the optical fiber 10A11 of the active system in the sensing unit SA1 of the active system (No in step S32), processing returns to the step S31.

On the other hand, when it is determined that a fault has occurred in the optical fiber 10A11 of the active system in the sensing unit SA1 of the active system (Yes in step S32), then the control device 30 determines whether it is possible to cope with switching of the channel CH of the sensing unit SA1 (step S33). For example, when both the processing unit 24A1 and the optical fiber 10A12 of the standby system in the sensing unit SA1 are normal (i.e., there is no occurrence of a fault), the control device 30 determines that it is possible to cope with switching of the channel CH of the sensing unit SA1, and otherwise, determines that it is not possible to cope with switching of the channel CH of the sensing unit SA1.

When it is determined that it is possible to cope with switching of the channel CH of the sensing unit SA1 (Yes in step S33), then the control device 30 performs switching the channel CH in such a way as to continue to execute sensing by using the optical fiber 10A12 of the standby system in the sensing unit SA1 of the active system (step S34).

On the other hand, when it is determined that it is not possible to cope with switching of the channel CH of the sensing unit SA1 (No in step S33), then, the control device 30 performs switching the sensing unit S in such a way as to continue to execute sensing by using any of the optical fibers 10 of the standby system in any of the sensing units S of the standby system (step S35). At this time, the control device 30 determines the optical fiber 10 for executing sensing from the optical fibers 10 connected to the normal processing unit 24 among the normal optical fibers 10 of the standby system. Further, the control device 30 may determine the optical fiber 10 for executing sensing from the optical fibers 10 connected to the normal processing unit 24 among the normal optical fibers 10 of the standby system included in the sensing unit S that is not under maintenance.

As described above, according to the third example embodiment, when it is determined that a fault has occurred in the optical fiber 10 of the active system in the sensing unit S of the active system, the control device 30 performs switching the channel CH in such a way as to continue to execute sensing by using the optical fiber 10 of the standby system in the sensing unit S of the active system, or performs switching the sensing unit S in such a way as to continue to execute sensing by using the optical fiber 10 of the standby system in the sensing unit S of the standby system. Thereby, even when a fault occurs in the optical fiber 10 of the active system in the sensing unit S of the active system, sensing can be continued by using any of the optical fibers 10 of the standby system in the sensing unit S of the active system or the standby system. As a result, occurrence of a security hole can be suppressed to a minimum.

Next, a modification example of the configuration in FIG. 10 according to the third example embodiment will be described below.

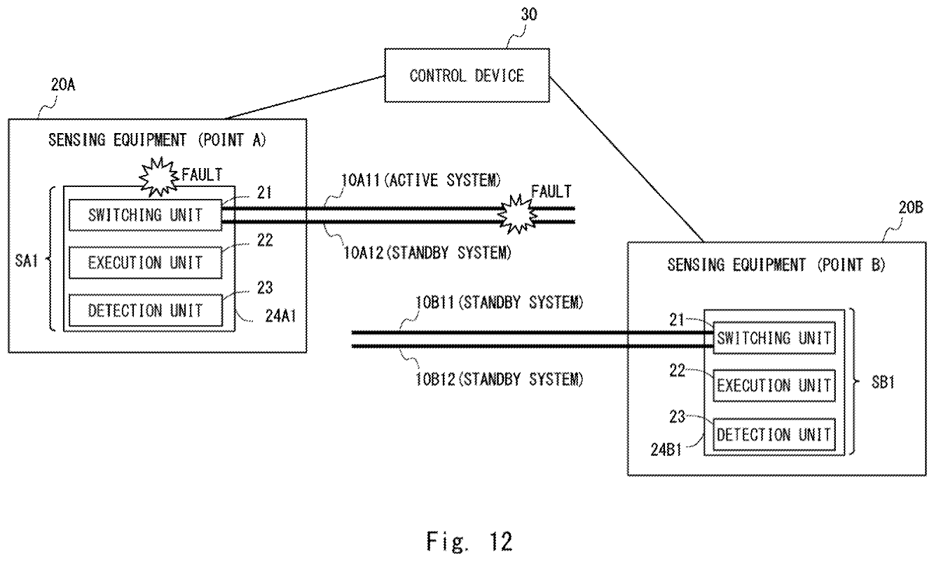

First, a configuration example of the optical fiber sensing system according to a first modification example of the third example embodiment will be described with reference to FIG. 12.

FIG. 10 illustrates an example in which n processing units 24 are arranged at the same point.

On the other hand, as illustrated in FIG. 12, the first modification example of the third example embodiment is an example in which two processing units 24A1 and 24B1 are arranged at points different from each other.

Specifically, the first modification example of the third example embodiment differs, in comparison with the configuration in FIG. 8 according to the second example embodiment described above, in that each of sensing units SA1 and SB1 includes two optical fibers 10 being redundantly laid. In detail, the sensing unit SA1 includes two optical fibers 10A11 and 10A12, and the sensing unit SB1 includes two optical fibers 10B11 and 10B12. Note that, each of the sensing units SA1 and SB1 is not limited to including two optical fibers 10, and may include three or more optical fibers 10. In a state in FIG. 12, the sensing unit SA1 is in the active system, and the sensing unit SB1 is in the standby system. Further, the optical fiber 10A11 in the sensing unit SA1 is in the active system, and the remaining optical fibers 10A12, 10B11, and 10B12 are in the standby system.

In the first modification example of the third example embodiment, the two processing units 24A1 and 24B1 are arranged at points different from each other. Therefore, for example, even when a fault occurs in the processing unit 24A1 of the sensing unit SA1 of the active system due to a fault of optical fiber sensing equipment 20A itself, sensing can be continued by the sensing unit SB1. Further, each of the sensing units SA1 and SB1 includes two optical fibers 10. Therefore, for example, even when a fault occurs in the optical fiber 10A11 of the active system in the sensing unit SA1 of the active system, it is possible to continue sensing by using any of the optical fibers 10A12, 10B11, and 10B12 of the standby system.

Note that, the first modification example of the third example embodiment is an example in which an arranged location of the processing unit 24 is two points, but the arranged location of the processing unit 24 may be three or more points.

Further, in the third example embodiment, as an alternative configuration to the configuration in which the sensing unit S includes two optical fibers 10 being redundantly laid, the sensing unit S may include one optical fiber 10 having a loop structure as illustrated in FIG. 4.

### Other Example Embodiments

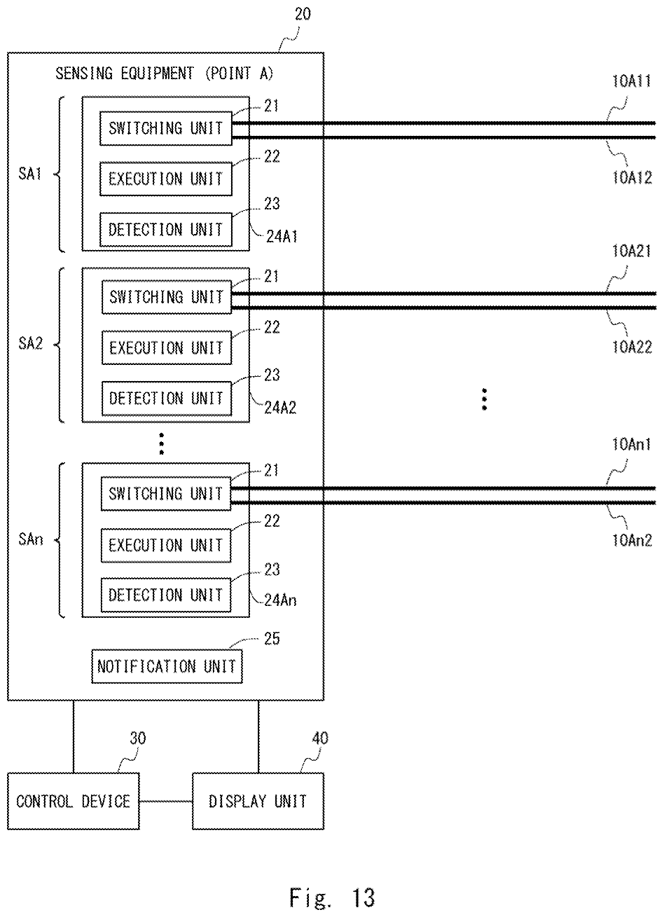

In the third example embodiment described above, a sensing unit S is redundantly configured, and further, an optical fiber 10 of each sensing unit S is redundantly configured. Therefore, sensing is executed by using any of the optical fibers 10 in any of the sensing units S. At this time, the sensing unit S and the optical fiber 10 executing sensing may be notified. FIG. 13 illustrates an example of a configuration of an optical fiber sensing system for performing the notification.

The optical fiber sensing system illustrated in FIG. 13 is different, in comparison with the configuration in FIG. 10 of the above-described third example embodiment, in that a display unit 40 is added and a notification unit 25 is added to optical fiber sensing equipment 20.

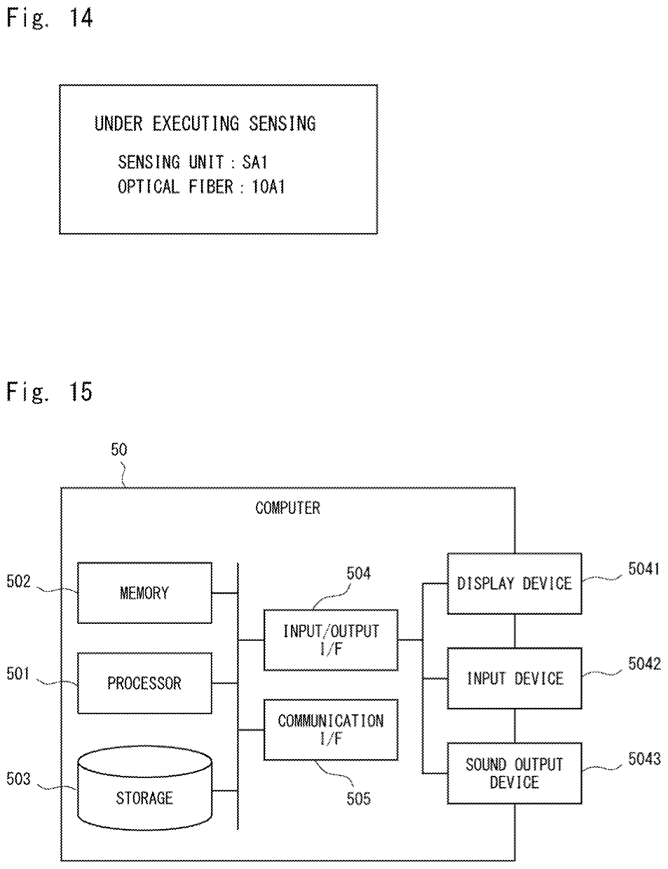

The notification unit 25 notifies the sensing unit S and the optical fiber 10 executing sensing. A notification destination may be, for example, a monitoring system, a monitoring room, or the like that monitors a monitoring area. Further, a notification method may be, for example, a method of displaying a graphical user interface (GUI) screen on the display unit 40 such as a display or a monitor in a notification destination. FIG. 14 illustrates an example when the notification is performed on the GUI screen. FIG. 14 illustrates an example of a GUI screen when sensing is executed by using an optical fiber 10A1 in a sensing unit SA1. Further, the notification method may be a method in which a message is output as sound from a speaker in a notification destination.

Further, in the example embodiment described above, when occurrence of a fault of the optical fiber 10 is detected and the fault occurs in the optical fiber 10, a channel CH or the sensing unit S is performed switching, but the present invention is not limited thereto. For example, a deterioration state of the optical fiber 10 may be detected, and the channel CH and the sensing unit S may be performed switching according to a degree of deterioration of the optical fiber 10.

### <Hardware Configuration of Optical Fiber Sensing Equipment>

Next, a hardware configuration of a computer 50 that achieves optical fiber sensing equipment 20, 20A, and 20B will be described below with reference to FIG. 15.

As illustrated in FIG. 15, the computer 50 includes a processor 501, a memory 502, a storage 503, an input/output interface (input/output I/F) 504, a communication interface (communication I/F) 505, and the like. The processor 501, the memory 502, the storage 503, the input/output interface 504, and the communication interface 505 are connected to one another through a data transmission path for transmitting and receiving data.

The processor 501 is, for example, an arithmetic processing unit such as a central processing unit (CPU) or a graphics processing unit (GPU). The memory 502 is, for example, a memory such as a random access memory (RAM) or a read only memory (ROM). The storage 503 is, for example, a storage device such as a hard disk drive (HDD), a solid state drive (SSD), or a memory card. Further, the storage 503 may be a memory such as a RAM or a ROM.

The storage 503 stores a program for achieving a function of components (a switching unit 21, an execution unit 22, a detection unit 23, and a notification unit 25) included in the optical fiber sensing equipment 20, 20A, and 20B. The processor 501 executes each program, and thereby each function of the components included in the optical fiber sensing equipment 20, 20 A, and 20 B is achieved.

Herein, when executing the above-mentioned each program, the processor 501 may execute these programs after reading them onto the memory 502, or may execute them without reading them onto the memory 502. Further, the memory 502 and the storage 503 also serve to store information and data held by the component included in the optical fiber sensing equipment 20, 20A, and 20B.

In addition, the program described above can be stored by using various types of non-transitory computer readable media, and supplied to a computer (including the computer 50). The non-transitory computer readable medium includes various types of tangible storage media. Examples of the non-transitory computer readable medium include a magnetic recording medium (e.g., a flexible disk, a magnetic tape, a hard disk drive), a magneto-optical recording medium (e.g., a magneto-optical disk), a compact disc-ROM (CD-ROM), a CD-recordable (CD-R), a CD-rewritable (CR-R/W), and a semiconductor memory (e.g., a mask ROM, a programmable ROM (PROM), a erasable PROM (EPROM), a flash ROM, and a RAM. Further, the program may also be supplied to the computer by various types of transitory computer readable media. Examples of the transitory computer readable medium include an electrical signal, an optical signal, and an electromagnetic wave. The transitory computer readable medium may supply the program to the computer via a wired communication path such as an electric wire and an optical fiber, or a wireless communication path.

The input/output interface 504 is connected to a display device 5041, an input device 5042, a sound output device 5043, and the like. The display device 5041 is a device for displaying a screen associated with drawing data processed by the processor 501, such as a liquid crystal display (LCD), a cathode ray tube (CRT) display, or a monitor. The input device 5042 is a device for accepting an operation input from an operator, and is, for example, a keyboard, a mouse, a touch sensor, or the like. The display device 5041 and the input device 5042 may be integrated and achieved as a touch panel. The sound output device 5043 is a device for acoustically outputting a sound associated with sound data processed by the processor 501, such as a speaker.

The communication interface 505 transmits and receives data to and from an external device. For example, the communication interface 505 communicates with an external device via a wired communication path or a wireless communication path.

Although the present disclosure has been described above with reference to the example embodiments, the present disclosure is not limited to the example embodiments described above. Various modifications may be made to the structure and details of the present disclosure as will be understood by those skilled in the art within the scope of the present disclosure.

For example, some or all of the above-described example embodiments may be used in combination with each other.

In addition, some or all of the above-described example embodiments may be described as the following supplementary note, but the present invention is not limited to the following.

(Supplementary Note 1)

An optical fiber sensing system including:

a sensing optical fiber configured to be redundantly laid;

an execution unit configured to execute sensing with the sensing optical fiber;

a detection unit configured to detect occurrence of a fault in a sensing optical fiber of an active system among the sensing optical fibers; and

a switching unit configured to perform switching in such a way that the execution unit executes sensing with a sensing optical fiber of a standby system among the sensing optical fibers when the detection unit determines that the fault has occurred.

(Supplementary Note 2)

The optical fiber sensing system according to Supplementary Note 1, wherein

the switching unit includes a plurality of channels to which the sensing optical fiber can be connected, and

the sensing optical fiber of the active system and the sensing optical fiber of the standby system are connected to channels different from each other in the switching unit.

(Supplementary Note 3)

The optical fiber sensing system according to Supplementary Note 1 or 2, wherein the sensing optical fiber of the active system and the sensing optical fiber of the standby system are constituted of one optical fiber.

(Supplementary Note 4)

The optical fiber sensing system according to any one of Supplementary Notes 1 to 3, wherein one of the sensing optical fiber of the active system and the sensing optical fiber of the standby system is laid in ground, and another is laid on ground.

(Supplementary Note 5)

An optical fiber sensing system including:

a first sensing unit configured to include a first sensing optical fiber and execute sensing with the first sensing optical fiber;

a second sensing unit configured to include a second sensing optical fiber and executes sensing with the second sensing optical fiber; and

a control device configured to detect an operating state of each of the first sensing unit and the second sensing unit,

wherein the control device performs switching in such a way as to execute sensing with the second sensing unit when it is determined that the first sensing unit becomes inoperable in a case where the first sensing unit is in an active system.

(Supplementary Note 6)

The optical fiber sensing system according to supplementary note 5, wherein

the first sensing unit includes

the first sensing optical fiber, and

a first processing unit configured to include at least a first execution unit configured to execute sensing with the first sensing optical fiber, and a first detection unit configured to detect occurrence of a fault in the first sensing optical fiber,

the second sensing unit includes

the second sensing optical fiber, and

a second processing unit configured to include at least a second execution unit configured to execute sensing with the second sensing optical fiber, and a second detection unit configured to detect occurrence of a fault in the second sensing optical fiber, and

the control device determines that the first sensing unit becomes inoperable when it is determined that a fault has occurred in either the first sensing optical fiber or the first processing unit.

(Supplementary Note 7)

The optical fiber sensing system according to Supplementary Note 6, wherein the first processing unit and the second processing unit are arranged at points different from each other.

(Supplementary Note 8)

The optical fiber sensing system according to any one of supplementary notes 5 to 7, further including a plurality of the second sensing units,

wherein the control device performs switching in such a way as to execute sensing with any of the second sensing units that are not under maintenance among the plurality of the second sensing units, when it is determined that the first sensing unit becomes inoperable in a case where the first sensing unit is in an active system.

(Supplementary Note 9)

The optical fiber sensing system according to any one of Supplementary Notes 5 to 8, wherein

the first sensing unit includes the first sensing optical fiber being redundantly laid, and

the second sensing unit includes the second sensing optical fiber being redundantly laid.

(Supplementary Note 10)

An optical fiber sensing method by an optical fiber sensing system, including:

a detection step of detecting occurrence of a fault in a sensing optical fiber of an active system among sensing optical fibers being redundantly laid; and

a switching step of performing switching in such a way as to execute sensing with a sensing optical fiber of a standby system among the sensing optical fibers when it is determined, in the detection step, that the fault has occurred.

(Supplementary Note 11)

The optical fiber sensing method according to Supplementary Note 10, wherein the sensing optical fiber of the active system and the sensing optical fiber of the standby system are connected to channels different from each other.

(Supplementary Note 12)

The optical fiber sensing method according to Supplementary Note 10 or 11, wherein the sensing optical fiber of the active system and the sensing optical fiber of the standby system are constituted of one optical fiber.

(Supplementary Note 13)

The optical fiber sensing method according to any one of Supplementary Notes 10 to 12, wherein one of the sensing optical fiber of the active system and the sensing optical fiber of the standby system is laid in ground, and another is laid on ground.

(Supplementary Note 14)

An optical fiber sensing method by an optical fiber sensing system, wherein

the optical fiber sensing system includes

a first sensing unit configured to include a first sensing optical fiber and executes sensing with the first sensing optical fiber, and

a second sensing unit configured to include a second sensing optical fiber and executes sensing with the second sensing optical fiber, and

the optical fiber sensing method includes

a detection step of detecting an operating state of each of the first sensing unit and the second sensing unit, and

a switching step of performing switching in such a way as to execute sensing with the second sensing unit when it is determined, in the detection step, that the first sensing unit becomes inoperable in a case where the first sensing unit is in an active system.

(Supplementary Note 15)

The optical fiber sensing method according to supplementary note 14, wherein

the first sensing unit includes

the first sensing optical fiber, and

a first processing unit configured to include at least a first execution unit configured to execute sensing with the first sensing optical fiber, and a first detection unit configured to detect occurrence of a fault in the first sensing optical fiber,

the second sensing unit includes

the second sensing optical fiber, and

a second processing unit configured to include at least a second execution unit configured to execute sensing with the second sensing optical fiber, and a second detection unit configured to detect occurrence of a fault in the second sensing optical fiber, and,

in the detection step, it is determined that the first sensing unit becomes inoperable when it is determined that a fault has occurred in either the first sensing optical fiber or the first processing unit.

(Supplementary Note 16)

The optical fiber sensing method according to Supplementary Note 15, wherein the first processing unit and the second processing unit are arranged at points different from each other.

(Supplementary Note 17)

The optical fiber sensing method according to any one of supplementary notes 14 to 16, wherein

the optical fiber sensing system includes a plurality of the second sensing units, and,

in the switching step, switching is performed in such a way as to execute sensing with any of the second sensing units that are not in maintenance among the plurality of the second sensing units, when it is determined, in the detection step, that the first sensing unit becomes inoperable in a case where the first sensing unit is in an active system.

(Supplementary Note 18)

The optical fiber sensing method according to any one of Supplementary Notes 14 to 17, wherein

the first sensing unit includes the first sensing optical fiber being redundantly laid, and

the second sensing unit includes the second sensing optical fiber being redundantly laid.

### REFERENCE SIGNS LIST

10A, 10A1 to 10An, 10A11 to 10An2, 10B1, 10B11, 10B12, 10C11,
10C12 Optical fiber
20, 20A, 20B Optical fiber sensing equipment
21 Switching unit
22 Execution unit
23 Detection unit
24, 24A1 to 24An, 24B1, 24C1 Processing unit
25 Notification unit
30 Control device
40 Display unit
50 Computer
501 Processor
502 Memory
503 Storage
504 Input/output interface
5041 Display device
5042 Input device
5043 Sound output device
505 Communication interface
CH1 to CH4 Channel
SA1 to SAn Sensing unit
F Fence

What is claimed is:

1. An optical fiber sensing system comprising:
a sensing optical fiber configured to be redundantly laid;
an execution unit configured to execute sensing with the sensing optical fiber;
a detection unit configured to detect occurrence of a fault in a sensing optical fiber of an active system among the sensing optical fibers; and
a switching unit configured to perform switching in such a way that the execution unit executes sensing with a sensing optical fiber of a standby system among the sensing optical fibers when the detection unit detects occurrence of the fault.

2. The optical fiber sensing system according to claim 1, wherein
the switching unit includes a plurality of channels to which the sensing optical fiber can be connected, and
the sensing optical fiber of the active system and the sensing optical fiber of the standby system are connected to channels different from each other in the switching unit.

3. The optical fiber sensing system according to claim 1, wherein the sensing optical fiber of the active system and the sensing optical fiber of the standby system are constituted of one optical fiber.

4. The optical fiber sensing system according to claim 1, wherein one of the sensing optical fiber of the active system and the sensing optical fiber of the standby system is laid in ground, and another is laid on ground.

5. An optical fiber sensing system comprising:
a first sensing unit configured to include a first sensing optical fiber and execute sensing with the first sensing optical fiber;
a second sensing unit configured to include a second sensing optical fiber and execute sensing with the second sensing optical fiber; and
a control device configured to detect an operating state of each of the first sensing unit and the second sensing unit,
wherein the control device performs switching in such a way as to execute sensing with the second sensing unit when it is detected that the first sensing unit becomes inoperable in a case where the first sensing unit is in an active system.

6. The optical fiber sensing system according to claim 5, wherein
the first sensing unit includes
the first sensing optical fiber, and
a first processing unit configured to include at least a first execution unit configured to execute sensing with the first sensing optical fiber, and a first detection unit configured to detect occurrence of a fault in the first sensing optical fiber,
the second sensing unit includes
the second sensing optical fiber, and
a second processing unit configured to include at least a second execution unit configured to execute sensing with the second sensing optical fiber, and a second detection unit configured to detect occurrence of a fault in the second sensing optical fiber, and
the control device detects that the first sensing unit becomes inoperable when occurrence of a fault in either the first sensing optical fiber or the first processing unit is detected.

7. The optical fiber sensing system according to claim 6, wherein the first processing unit and the second processing unit are arranged at points different from each other.

8. The optical fiber sensing system according to claim 5, further comprising a plurality of the second sensing units,
wherein the control device performs switching in such a way as to execute sensing with any of the second sensing units that are not under maintenance among the plurality of the second sensing units, when it is detected that the first sensing unit becomes inoperable in a case where the first sensing unit is in an active system.

9. The optical fiber sensing system according to claim 5, wherein
the first sensing unit includes the first sensing optical fiber being redundantly laid, and
the second sensing unit includes the second sensing optical fiber being redundantly laid.

10. An optical fiber sensing method by an optical fiber sensing system, comprising:
a detection step of detecting occurrence of a fault in a sensing optical fiber of an active system among sensing optical fibers being redundantly laid; and
a switching step of performing switching in such a way as to execute sensing with a sensing optical fiber of a standby system among the sensing optical fibers when occurrence of the fault is detected in the detection step.

11. The optical fiber sensing method according to claim 10, wherein the sensing optical fiber of the active system and the sensing optical fiber of the standby system are connected to channels different from each other.

12. The optical fiber sensing method according to claim 10, wherein the sensing optical fiber of the active system and the sensing optical fiber of the standby system are constituted of one optical fiber.

13. The optical fiber sensing method according to claim 10, wherein one of the sensing optical fiber of the active system and the sensing optical fiber of the standby system is laid in ground, and another is laid on ground.

14.-18. (canceled)
